(19) United States
(12) Patent Application Publication
(10) Pub. No.: US 2007/0025203 A1
(43) Pub. Date: Feb. 1, 2007

(54) Optical disk processing apparatus and optical disk processing method

(76) Inventors: You Yoshioka, Tokyo (JP); Naoto Mihara, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/491,908

(22) Filed: Jul. 25, 2006

(30) Foreign Application Priority Data
Jul. 26, 2005 (JP) 2005-216197

(51) Int. Cl. G11B 7/00

(52) U.S. Cl. 369/44.13

(57) ABSTRACT

According to one embodiment, there is provided a disk apparatus including a reading unit which reads a reflective light from a disk and outputs a read signal, an extracting unit which extracts a wobble signal from the read signal, an upper limit detector which detects an upper limit signal of the wobble signal, a lower limit detector which detects a lower limit signal of the wobble signal, an intermediate value generator which generates an intermediate value between the upper limit signal and the lower limit signal, a check unit which checks the wobble signal with the intermediate value defined as a threshold, a controller which controls an operation of the reading unit according to an address value depending on the result checked by the check unit, and a decoder which decodes the read signal from the operation-controlled reading unit and outputs a reproducing signal.

### CROSS-REFERENCE TO RELATED APPLICATIONS

This application is based upon and claims the benefit of priority from Japanese Patent Application No. 2005-216197, filed Jul. 26, 2005, the entire contents of which are incorporated herein by reference.

### BACKGROUND

1. Field

One embodiment of the invention relates to an optical disk apparatus, and more particularly to an optical disk apparatus which extracts and use a wobble signal and its optical disk processing method.

2. Description of the Related Art

In these days, an optical disk becomes widespread as an information recording medium and further improvement in the reliability is expected. In an optical disk apparatus, a wobble on a disk is read and the address information is extracted therefrom, to be used for a control operation.

In a wobble modulation in which an inversely phase-modulated position sometimes appears as a code in a main standard phase waveform (carrier), at a time of wobble phase detection of an optical disk, this optical disk apparatus creates a reference phase clock in a PLL having a long response time constant, sequentially detects the relative phase with this as a reference, and identifies the code with a fixed threshold positioned at the same distance from the reference phase and the code phase. In an HD DVD-R where phase arrangement is irregular (the reference phases of the adjacent tracks do not agree with each other), phase interference affected by the adjacent tracks, however, results in offset in the reading phase, which presses the distance between codes for modulation code discrimination. In other words, though the distance between a fixed threshold and each detection phase of each code is essentially equal, the interference from the adjacent track makes the distance unequal and the usual threshold for code check becomes unsuitable.

As an optical disk apparatus which reads a wobble, Patent document 1 (Jpn. Pat. Appln. KOKAI Publication No. 2005-85407) discloses an optical disk apparatus in which a threshold is calibrated with asymmetricity of a phase detection signal.

However, in a disk having the interference from the adjacent track in a push-pull signal having read the wobble and including a lot of low band noises in the push-pull signal, a phase detection signal is not calibrated fully but a code reading error occurs.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of the structure of an optical disk apparatus according to one embodiment of the invention;

FIG. 2 is a view for use in describing one example of wobbles of an optical disk handled by the optical disk apparatus according to the embodiment of the invention;

FIG. 3 is a view showing one example of the structure of a physical segment of a wobble signal handled by the optical disk apparatus according to the embodiment of the invention;

FIG. 4 is a view showing an example of the modulation position of the wobble signal handled by the optical disk apparatus according to the embodiment of the invention;

FIG. 5 is a view showing one example of the segment types of the wobble signal handled by the optical disk apparatus according to the embodiment of the invention;

FIG. 6 is a view showing one example of the coding structure of the wobble signal handled by the optical disk apparatus according to the embodiment of the invention;

FIG. 7 is a timing chart for use in describing one example of misreading caused by the noises on the wobbles, in the general optical disk apparatus;

FIG. 8 is a timing chart for use in describing one example of reading processing of high noise immunity as a result of reading processing by the optical disk apparatus according to the embodiment of the invention; and

FIG. 9 is a timing chart for use in describing another example of reading processing of high noise immunity as a result of reading processing and adjustment of response speed by the optical disk apparatus according to the embodiment of the invention.

### DETAILED DESCRIPTION

Various embodiments according to the invention will be described hereinafter with reference to the accompanying drawings. In general, according to one embodiment of the invention, there is provided a disk apparatus comprising: a reading unit which reads a reflective light from a disk and outputs a read signal; an extracting unit which extracts a wobble signal from the read signal; a phase detector which detects a phase of the wobble signal from the extracting unit; an upper limit detector which detects an upper limit signal of the wobble signal according to the detection result of the phase detector; a lower limit detector which detects a lower limit signal of the wobble signal according to the detection result of the phase detector; an intermediate value generator which generates an intermediate value between the upper limit signal and the lower limit signal; a check unit which checks the wobble signal with the intermediate value defined as a threshold; a controller which controls an operation of the reading unit according to an address value depending on the result checked by the check unit; and a decoder which decodes the read signal from the operation-controlled reading unit and outputs a reproducing signal.

This is to provide an optical disk apparatus which can perform a stable reading operation free from reading error, through the assured address identification, when it has the phase interference from the adjacent tracks and the low band noise.

In other words, this is to provide an optical disk apparatus which can identify the address reliably even when a push-pull signal having read the wobbles is subject to the interference from the adjacent tracks and includes a lot of low band noises.

Hereinafter, embodiments of the invention will be described in detail with reference to the drawings.

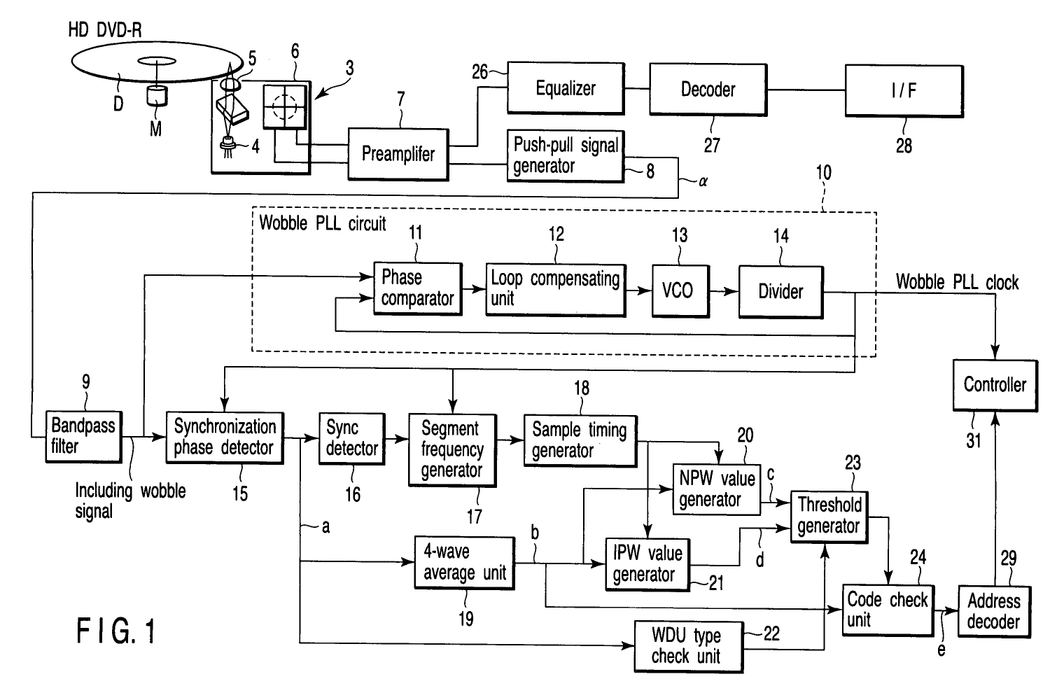

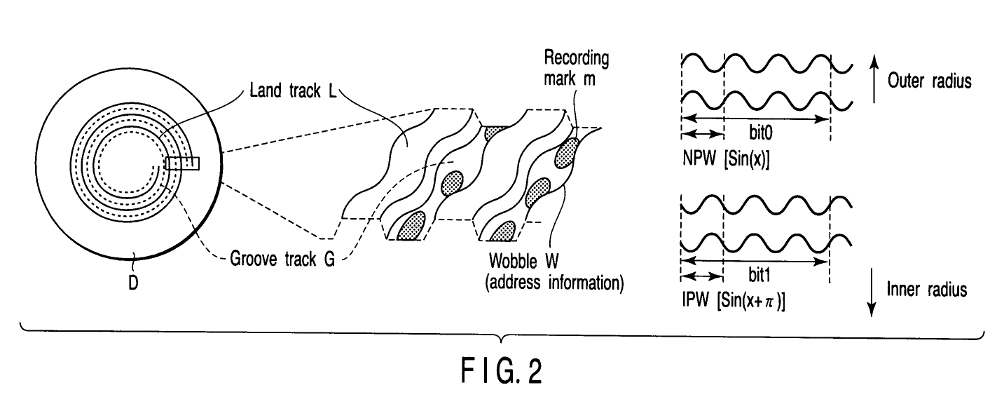

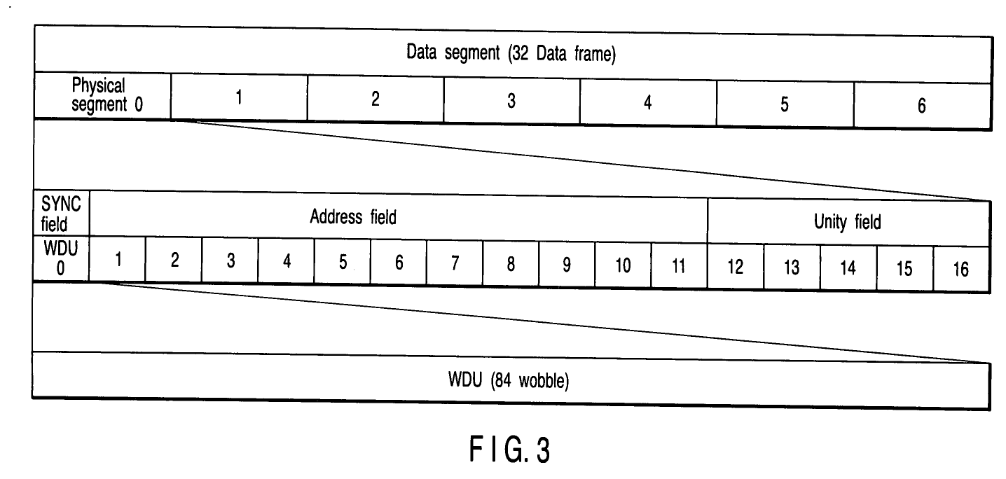

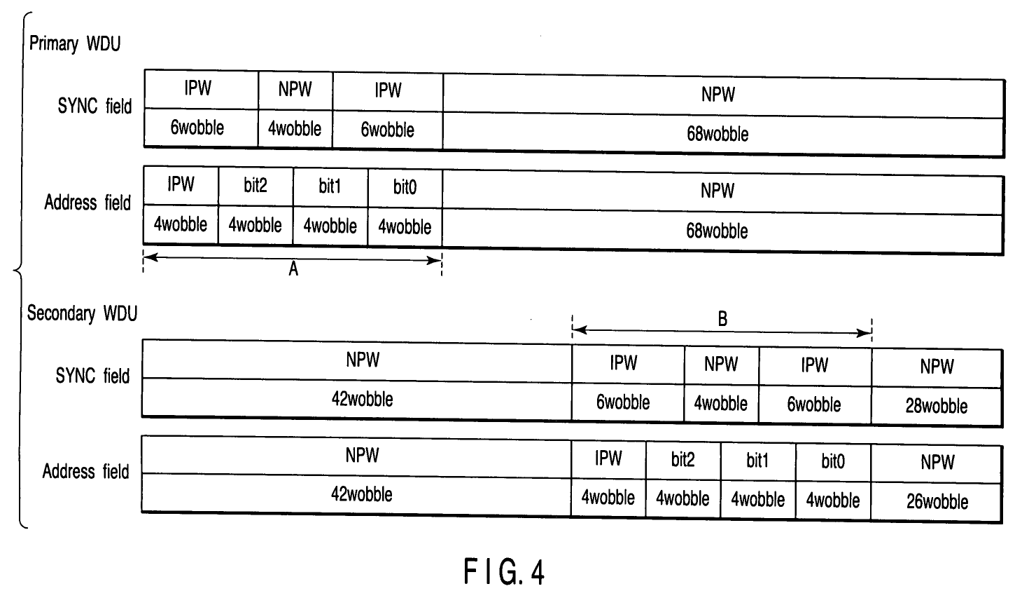

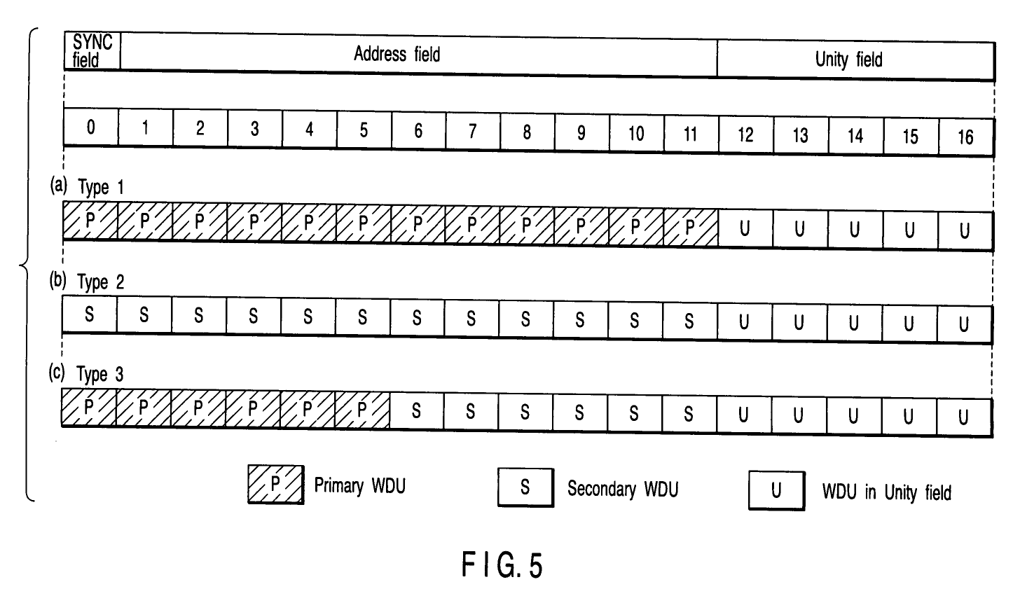

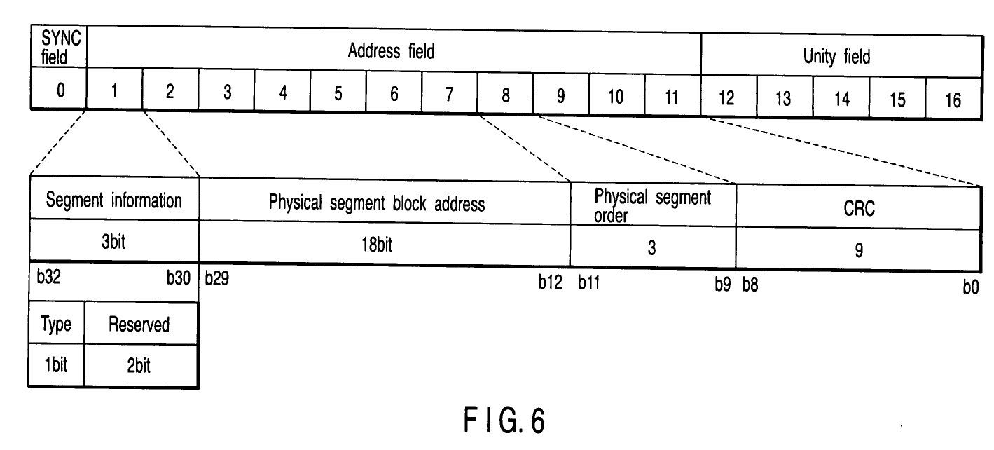

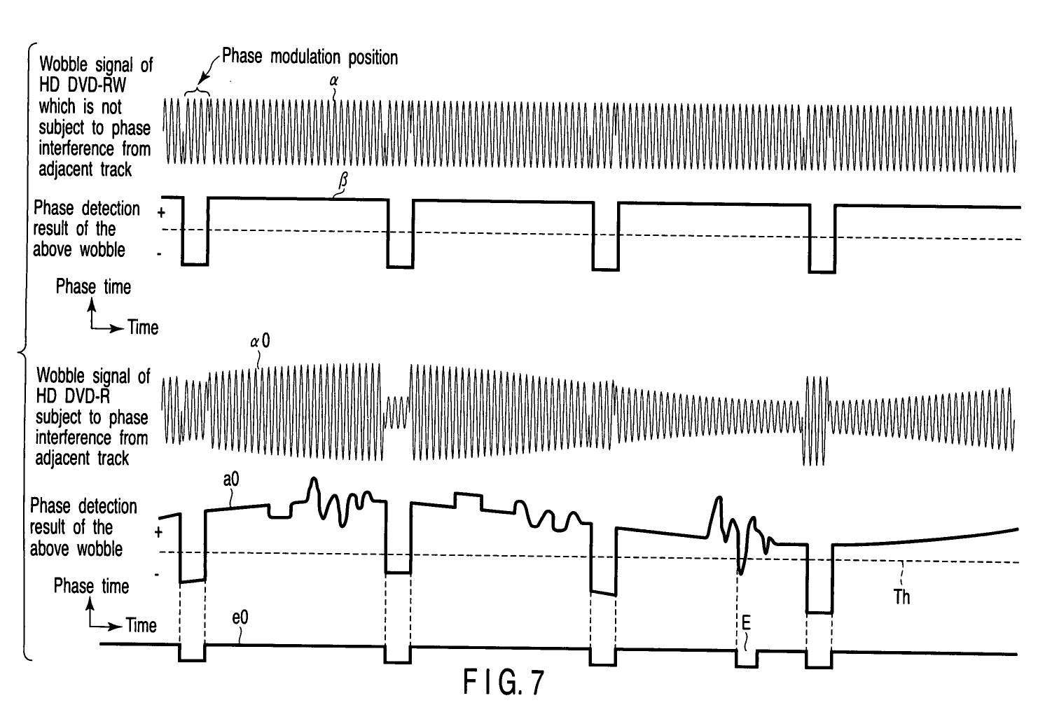

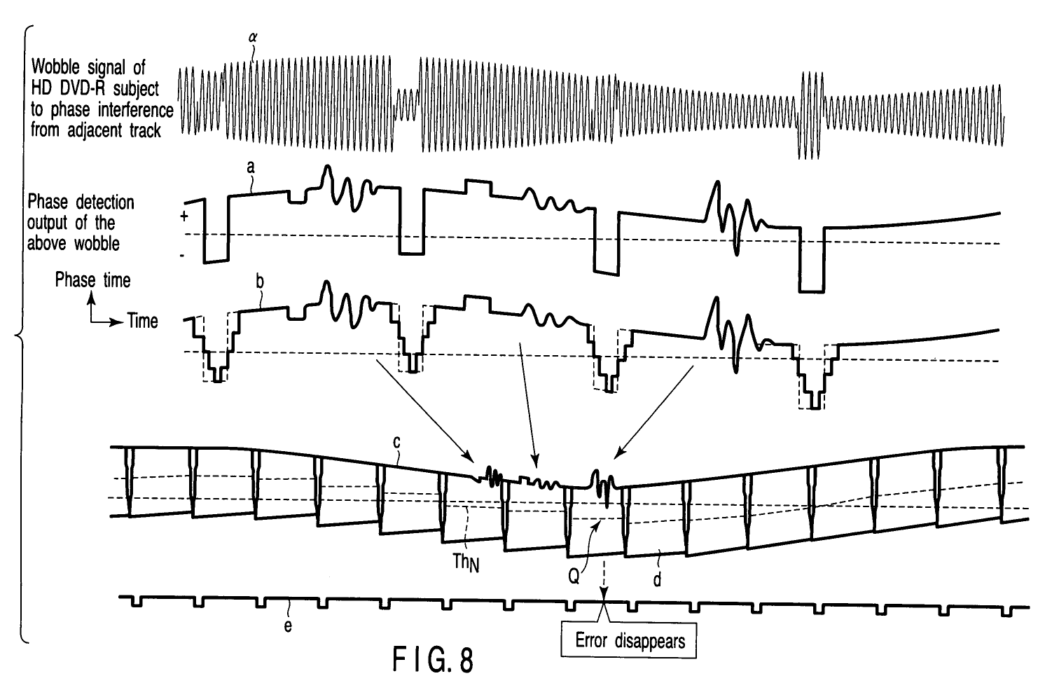

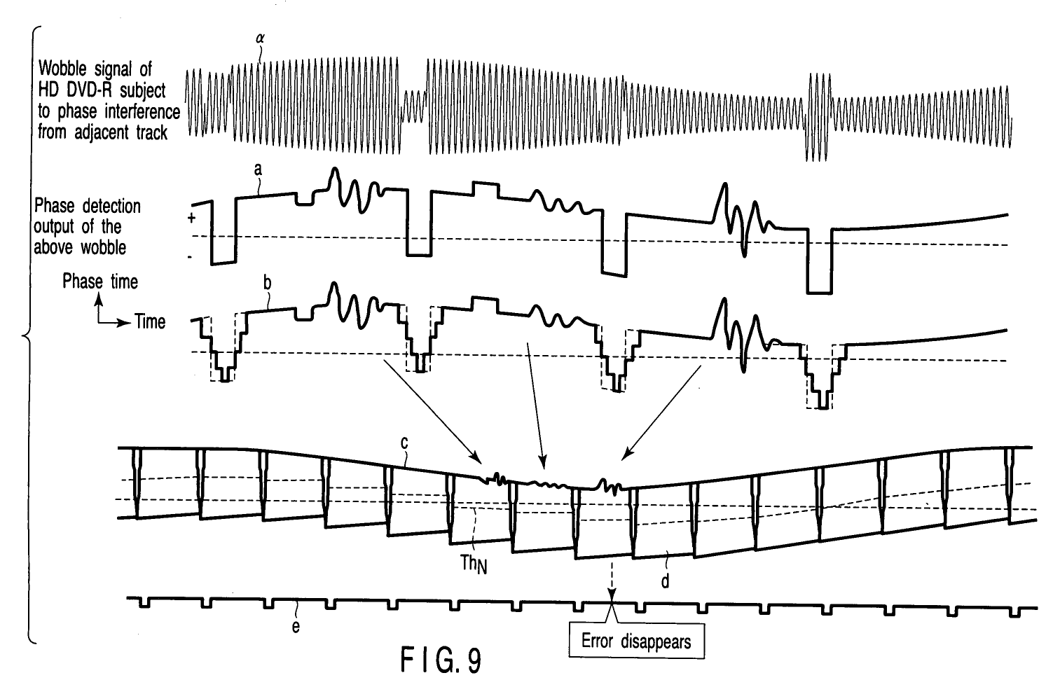

At first, FIG. 1 is a block diagram showing one example of the structure of an optical disk apparatus according to one embodiment of the invention; FIG. 2 is a view for use in describing one example of the wobbles of an optical disk handled by the optical disk apparatus according to the embodiment of the invention; FIG. 3 is a view showing one example of the structure of a physical segment of the wobble signal thereof; FIG. 4 is a view showing an example of the modulation position of the same wobble signal; FIG. 5 is a view showing one example of the segment types of the same wobble signal; FIG. 6 is a view showing one example of the coding structure of the same wobble signal; FIG. 7 is a timing chart for use in describing one example of misreading caused by the noises on the wobbles, in the general optical disk apparatus; FIG. 8 is a timing chart for use in describing one example of reading processing of high noise immunity as a result of reading processing by the optical disk apparatus according to the embodiment of the invention; and FIG. 9 is a timing chart for use in describing another example of the reading processing of high noise immunity as a result of reading processing and adjustment of response speed by the same optical disk apparatus.

### One Example of an Optical Disk Apparatus According to One Embodiment of the Invention

An optical disk apparatus according to one embodiment of the invention obtains the upper limit and the lower limit of a wobble signal and discriminates a code with the intermediate value thereof defined as a threshold, even when a push-pull signal having read the wobbles is subject to the interference from the adjacent tracks and includes a lot of low band noises. This provides an optical disk apparatus which can detect the address information free from misjudgment and perform a control operation based on this information. At first, one example of the optical disk apparatus according to the embodiment of the invention will be described in detail using FIG. 1.

### Structure

An optical disk apparatus that is one embodiment of the invention is to use an optical disk D, such as, an HD DVD as an example, in FIG. 1. The optical disk apparatus comprises a pickup 3 which converts a reflective light from a reference beam focused on the groove recording surface of the disk D into a voltage signal, a preamplifier 7 which amplifies a signal outputted from the pickup 3, a push-pull signal generator 8 which outputs a push-pull signal upon receipt of the amplified signal, and a controller 31 which controls the whole operations and the operation of the pickup 3. Further, in order to add a function of reproducing general RF signals, the optical disk apparatus comprises an equalizer 26 which receives the output of the preamplifier 7, a decoder 2 which performs the MPEG decoding processing on this output, and an I/F 28 which supplies the output of the decoder to an external device (not shown).

The optical disk apparatus further comprises a bandpass filter 9 which performs the filtering processing upon receipt of a difference signal (this push-pull signal includes a wobble signal of pre-groove) between the signals of the detectors that are in the areas resulted from dividing a reflective light flux from the push-pull signal generator 8 into two in a radial direction. This bandpass filter 9 eliminates an RF leakage signal, a residual signal, an adjacent clear signal, a tracking servo following residual signal, and the like other than the wobble included in the push-pull signal, according to the discrimination of frequencies, in order to make it easy to read the phase of a wobble signal. Since this characteristic may be a waveform distortion or a phase shift as for the wobble wave and therefore, it is effective in providing a mechanism of frequency-tracking the reproducing linear speed depending on the necessary phase precision. Alternatively, only when there are a lot of noises, the BPF is used, or it is preferable that the characteristic of the BPF is changed selectively after detecting the situation; for example, the selection characteristic is intensified, and the like.

The optical disk apparatus comprises a wobble PLL circuit 10 which receives a wobble signal from the bandpass filter 9. The wobble PLL circuit 10 generates a single clock following the phase of the input wobble signal. In addition, the wobble PLL circuit 10 includes a phase comparator 11, a loop compensating unit 12 which receives an output of the phase comparator 11, a VOC 13 which receives an output of the loop compensating unit 12, and a divider 14 which receives an output of the VOC 13. The original frequency oscillated by the VCO 13 is lowered to the wobble frequency by the divider 14, the phase difference information between this and the input wobble is extracted by the phase comparator 11, a necessary control band and control gain are adjusted by the loop compensating unit 12, and this is fed back to the VCO 13, thereby forming the PLL. This wobble PLL clock is supplied to the controller 31 for controlling the whole operations and the operation of the pickup 3.

In other words, in a method for preventing the PLL operation from being affected by a code modulated position, the appearance of a code is detected from the detection result of the phase 90° shifted from the detection axis, and the control polarity of the loop of the PLL is inverted or muted, or the last value is held, or the average value is held, or the like based on the detection result.

As the additional method, the position of a code is predicted according to the regularity of the codes coming, and when the above processing is performed during that time only, it is possible to avoid such an accident that a malfunction occurs at a position other than the code.

Here, there is a position where the physical address is embedded according to the phase modulation in the wobble and the phase is temporarily inverted. By setting the following time constant of the PLL at such a high value that it does not respond to this, it is possible to generate a clock of a reference phase (PLL clock) free from much influence from the code modulated position.

Further, the optical disk apparatus comprises a synchronization phase detector 15 for receiving the PLL clock and the wobble signal and the following structure for calibrating a threshold, that is one embodiment of the invention. Specifically, in FIG. 1, the optical disk apparatus comprises a sync detector 16 to which the output of the synchronization phase detector 15 is connected, a segment frequency generator 17 which receives the output of the sync detector 16, a sample timing generator 18, an NPW value generator 20 and an IPW value generator 21 which receive the respective outputs, a threshold generator 23 which generates a threshold according to these values, a code check unit 24 which checks a code with this threshold, and an address decoder 29 which decodes the address according to the checked code signal e and supplies it to the controller 31. The optical disk apparatus further comprises a 4-wave average unit 19 which generates a 4-wave average from the signal of the synchronization phase detector 15 and a WDU type check unit 22 which checks whether the type of WDU (Wobble Data Unit) is primary or secondary, from the signal of the synchronization phase detector 15 and supplies the result to the threshold generator 23.

### One Example of the Structure of Wobble Handled by the Optical Disk Apparatus

The structure of the wobbles of an optical disk handled by the optical disk apparatus having the above structure will be specifically described below using FIGS. 2 to 6.

FIG. 2 shows the state in which a pre-groove is wobbled in the HD DVD-R. A wobble is provided along a land track L and a groove track G on the disk D as undulation of the land track L. Here, with the start point of the track segment defined as a reference, the wobble phase that is of the sinusoidal wave, which starts swinging toward the outer radius of the disk is defined as NPW (non-inverting phase wobble), and the phase which starts swinging toward the inner radius of the disk is defined as IPW (inverting phase wobble), and then, information is recorded with the wobble modulation code “0” as for the NPW 4-wave and the code “1” as for the IPW 4-wave.

FIG. 3 shows the structure within the segment in the HD DVD-R. In FIG. 3, one data segment is formed by seven physical segments, and one physical segment is formed by 17 WDUs. One WDU has length of 84 wobbles.

First WDUO is for a SYNC field, where the SYNC pattern is modulated. In the following WDU1-WDU11, the physical address is coded for every three bits. The following WDU12-WDU16 are non-modulation areas as apparent from FIG. 3.

FIG. 4 shows the code modulation position in the WDU. Here, there are two types of WDUs; primary and secondary. In the primary WDU, the modulated portion exists in the head of the WDU, and in the secondary WDU, the modulated portion is positioned after 42 wobbles and later from the head. In the SYNC field, six IPWs, four NPWs, and six IPWs are aligned from the head, and in the address field, after four IPWs as the head identifier, address data is recorded for three bits by using four wobbles per one bit.

In the HD DVD-R of the CLV method, since the length of one circular track gradually changes according to the principle of the CLV, the phase of the segment cycle between the adjacent tracks gradually deviates from each other. When the code modulation position is located at a fixed position within the segment, the adjacent track and the code come together and the phase interference becomes complicated. This disk standard includes two types of code modulation positions; the first half (primary) and the latter half (secondary) within the WDU, and by this combination, a code can be surely prevented from coming together with the adjacent track.

FIG. 5 shows the examples of the combination of the primary and the secondary as type 1, type 2, and type 3.

In addition, FIG. 6 shows an example of the structure of the wobble coding. Here, an example of the specific structure of the SYNC field, the address field, and the unity field is specifically shown.

### Operation: First Embodiment

The processing of the wobble signal for preventing reading error even in the event of phase interference from the adjacent tracks and low band noises, in the optical disk apparatus according to the embodiment of the invention will be specifically described using the drawings.

In the first embodiment, the phase of a wobble signal is detected and according to this detection result, a threshold for checking the wobble signal is created from an intermediate value between the upper limit signal and the lower limit signal of the upper limit wobble signal of the wobble signal, thereby checking the wobble signal by using the threshold. Further, samples for determining the upper limit signal and the lower limit signal of the wobble signal are restricted to the samples only belonging to the inverting area for the primary and the inverting area for the secondary, and then, the primary or secondary is checked in every several (six) WDUs, only the samples of one party are selected according to the check result, thereby determining the upper limit signal and the lower limit signal.

### When a Reading Error Occurs

At first, a reading error happening in the ordinary optical disk apparatus will be described using FIG. 7. Assuming the ordinary optical disk apparatus, referring to the optical disk apparatus as shown in FIG. 1, it is considered that “a wobble signal free from the phase interference from the adjacent tracks” α in FIG. 7 is detected as the phase detection result β of FIG. 7, in the output of the code check unit 24.

The actual wobble signal, however, has the phase interference from the adjacent tracks, like the wobble signal α0 in FIG. 7, and further, since it has some noise, the output of the synchronization phase detector 15 is traced like the phase detection result a0 of FIG. 7.

It is to be noted that when the code check unit 24 checks a code with the usual threshold Th, a simple noise is misjudged to be a phase-inverted position, especially in an error signal E, as illustrated in FIG. 7. As a result, the error signal E is outputted. When a signal is affected by the noise as well as the phase interference from the adjacent tracks, this misjudgment often occurs, thereby deteriorating the reliability of the address and making it impossible to use it for the operation control of the pickup and the like.

### Code Check Processing According to the First Embodiment

The code check processing in the case of the first embodiment will be sequentially described in detail. The optical disk apparatus receives a difference signal (this push-pull signal includes a wobble signal of pre-groove) between the signals of detectors that are in the areas resulted from dividing a reflective light flux from the push-pull signal generator 8 into two in a radial direction. Upon receipt of the difference signal, the bandpass filter 9 eliminates an RF leakage signal, a residual signal, an adjacent clear signal, a tracking servo following residual signal, and the like other than the wobble included in the push-pull signal, according to the discrimination of frequencies, in order to make it easy to read the phase of the wobble signal.

The synchronization phase detector 15, upon receipt of the wobble signal from the bandpass filter 9, outputs a phase detection output a shown in FIG. 8 and supplies it to the sync detector 16.

The sync detector 16 detects the segment sync (synchronization waveform) from this output waveform pattern. The segment frequency generator 17 counts the cycle of one segment by the wobble PLL clock, with the segment sync defined as a reference point, through a flywheel counter. The sample timing generator 18 puts sample flags on 20 wobbles in total; the head 16 wobbles, where the modulation code is scheduled to come, plus two wobbles in its front portion and two wobbles in its back portion, in every WDU, according to the counter value of the segment frequency generator 17. Although the WDU means both the primary WDU and the secondary WDU, since there is no knowing which comes, in advance, it puts the sample flags on the both. Thus, as the common basic operation of each embodiment, it samples the maximum and the minimum of the 20 wobbles (16 wobbles+two wobbles in the front portion and two wobbles in the back portion) at the primary position and the 20 wobbles at the secondary position in every WDU.

The 4-wave average unit 19 4-wave averages the phase detection result a and outputs the 4-wave average result b.

The NPW value generator 20 holds the positive maximum value of the sample timing periods (the area A and the area B in FIG. 4) previously generated, as for the 4-wave average result b, and outputs the sample values (upper limit signals) per one WDU as for the primary/secondary separately.

Similarly, the IPW value generator 21 holds the negative maximum value of the sample timing periods (the area A and the area B in FIG. 4) as for 4-wave average result b, and outputs the sample values (lower limit signals) per one WDU as for the primary/secondary separately.

By restricting the timing for requiring the sample values to the area A and the area B in FIG. 4, the position of the phase inversion can be efficiently detected and unnecessary influence of the noise can be prevented.

The WDU type check unit 22 checks whether each WDU is of the primary type or the secondary type respectively as for the first half six WDUs and the latter half six WDUs, according to the result of the synchronization phase detection. The threshold generator 23 generates a threshold Th_{N} for use in code check, according to the NPW value and the IPW value outputted from each WDU.

The NPW value generator 20 collects NPW values generated in every WDU for the first half six WDUs, leaves the type values indicated by the result of the WDU type check unit 22, and makes one representative value (upper limit signal) c during the period of six WDUs according to these values. The representative value is made preferably according to the average value of the six, the average value of the remaining four except the maximum and the minimum values (the average value of the second to the fifth largest ones), or the average value of the remaining two except the maximum two and the minimum two (the average value of the third and the fourth largest ones).

The IPW generator 21 makes a representative value (lower limit signal) d of the first half six WDUs by averaging the results of the type check as for the IPW values, similarly to the NPW.

The threshold generator 23 outputs the value positioned at the same distance from the representative values of the NPWs and the IPWs (average value) as the code check threshold Th_{N}. Upon receipt of the check threshold Th_{N}, the code check unit 24 checks the output of the 4-wave average unit 19 and provides the result as the detection result e of the modulation code.

Similarly as for the latter half six WDUs, a representative value is obtained and a threshold is generated. Thus, as apparent from the relationship between the upper limit signal c, the lower limit signal d, and the threshold Th_{N} in FIG. 8, by determining the threshold Th_{N}, the signal becomes free from the influence of noise and error generation in the judgment Q of FIG. 8. Since the threshold Th_{N} corresponding to a change of the phase interference from the adjacent tracks can be generated at least in every half segment, a code check of error frequency lower than the fixed threshold Th in the case of FIG. 7 is enabled. In addition, a stable threshold free from noise can be obtained.

### Operation: Second Embodiment

In the second embodiment, a threshold for checking a wobble signal is generated according to an intermediate value of the upper limit signal and the lower limit signal created depending on the detection result of detecting the phase of the wobble signal, thereby checking the wobble signal according to this threshold. Further, samples for determining the upper limit signal and the lower limit signal of the wobble signal are restricted to those belonging to the inverting area for the primary and the inverting area for the secondary, and then, a threshold is generated according to an intermediate value between the upper limit signal and the lower limit signal of the primary-wobble signal in every several (six) WDUs, and the wobble signal is checked according to the threshold. Representative values as for the NPWs and the IPWs generated in every WDU are determined according to the peak detection and the bottom detection having the attack/release time constants. In order to simplify the first embodiment, check result as for a plurality of WDUs is not required.

Namely, although in the first embodiment, the representative values of the NPWs (the upper limit signal) and the IPWs (the lower limit signal) are calculated in every six WDUs, in the second embodiment, the NPW value generator 20 and the IPW value generator 21 calculates a representative value one after another in every WDU (not calculate in every six WDUs).

Specifically, in the NPW value generator 20 and the IPW value generator 21 of FIG. 1, sampling periods are provided in the front and the back portions of the code in every WDU, and the peak detection and the bottom detection having the attack/release time constants are performed, thereby obtaining the NPW representative value and the IPW representative value. The respective attack time constants may be close to the complete attack, while the release time constants are preferably at a speed just only following a change of the phase interference between the tracks. Through the peak detection and the bottom detection having the attack/release time constants, it is possible to prevent a situation of outputting an extraordinary threshold as for a momentary noise and a comparatively stable code check is enabled.

### Operation: Third Embodiment

A third embodiment is made by simplifying the first embodiment. A threshold for checking a wobble signal is generated according to an intermediate value between the upper limit signal and the lower limit signal of the wobble signal and the threshold is used in order to check the wobble signal.

Similarly to the second embodiment, the NPW value generator 20 and the IPW value generator 21 of FIG. 1 determine the representative values according to the sequential calculation in every WDU in the third embodiment. However, as the processing for retarding a response speed, the third embodiment does not perform the statistical processing all over a plurality of WDUs like the first embodiment nor the peak/bottom detection with the attack/release time constants like the second embodiment.

Therefore, the third embodiment can achieve a higher response speed than that of the first and the second embodiments, and even when the phase interference amount rapidly changes in the case of a special disk having the larger phase interference than the standard, a proper threshold can be generated.

### Operation: Fourth Embodiment

The fourth embodiment is made by simplifying the first embodiment. Though a representative value is determined in every WDU similarly to the second embodiment, it is determined while retarding the response speed as for not only a sample near the code but also the result of the 4-wave average phase detection all over the whole period of time, as a method of generating a representative value of the NPWs.

Namely, the fourth embodiment is to determine the representative values that are the upper limit signal and the lower limit signal of a wobble signal, while retarding the response speed as shown in FIG. 9, by making the time constants on the circuit different or by performing a slew rate control on the program in the NPW value generator 20 and the IPW value generator 21 of FIG. 1. The control slew rate is preferably set at a value just only following a change of the phase interference between the tracks. The processing of the IPW is performed by the bottom detection in the same way as the second embodiment. As for the peak value, sampling processing is not performed.

Namely, although in the fourth embodiment, the processing on the side of the IPWs is the same as that in the second embodiment, sampling for the period of 20 wobbles is not performed on the side of the NPWs but a signal with the response speed delayed is created as for all the input signals and used for generating a threshold.

The fourth embodiment can achieve an operational stability through the address detection having the same noise immunity, while reducing the burden in the circuit structure and the processing according to the more simplified processing than that of the first embodiment.

According to the above mentioned various embodiments, those skilled in the art can realize the invention, but further various modification of these embodiments can be easily made by those skilled in the art and the invention can be applied to various embodiments without the inventive ability. Therefore, the invention covers a wide range which does not conflict with the disclosed principle and new features and it is not restricted to the above mentioned embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk apparatus comprising:
a reading unit which reads a reflective light from a disk and outputs a read signal;
an extracting unit which extracts a wobble signal from the read signal;
a phase detector which detects a phase of the wobble signal from the extracting unit;
an upper limit detector which detects an upper limit signal of the wobble signal according to the detection result of the phase detector;
a lower limit detector which detects a lower limit signal of the wobble signal according to the detection result of the phase detector;
an intermediate value generator which generates an intermediate value between the upper limit signal and the lower limit signal;
a check unit which checks the wobble signal with the intermediate value defined as a threshold;
a controller which controls an operation of the reading unit according to an address value depending on the result checked by the check unit; and
a decoder which decodes the read signal from the operation-controlled reading unit and outputs a reproducing signal.

2. The disk apparatus according to claim 1, wherein the upper limit detector and the lower limit detector respectively extract from the wobble signal only each portion of the wobble signal corresponding to a first half area and a latter half area of one WDU on the disk and respectively determine the upper limit signal and the lower limit signal referring to the above result.

3. The disk apparatus according to claim 1, wherein the upper limit detector and the lower limit detector perform signal detection with attack/release time constants.

4. The disk apparatus according to claim 2, wherein the upper limit detector and the lower limit detector select a first predetermined area or a second predetermined area for every six WDUs, select a wobble phase detection signal depending on the selected area, and determine the upper limit signal and the lower limit signal according to the above result.

5. The disk apparatus according to claim 1, wherein the upper limit detector and the lower limit detector determine the upper limit signal and the lower limit signal after retarding a response speed to the respective wobble phase detection signals.

6. A disk processing method comprising:
a step of reading a reflective light from a disk with a pickup unit and outputting a read signal;
a step of extracting a wobble signal from the read signal;
a step of detecting a phase of the wobble signal from the extracting unit;
a step of detecting an upper limit signal and a lower limit signal of the wobble signal according to the phase detection result;
a step of creating an intermediate value between the upper limit signal and the lower limit signal;
a step of checking the wobble signal with the intermediate signal defined as a threshold;
a step of controlling an operation of the pickup unit according to an address value depending on the check result; and
a step of decoding the read signal to output a reproducing signal.

7. The disk processing method according to claim 6, wherein in the detecting processing of the upper limit signal and the lower limit signal, only each portion of the wobble signal corresponding to a first half area and a latter half area of one WDU on the disk is extracted from the wobble signal, a phase is detected referring to the above result, and the upper limit signal and the lower limit signal are determined depending on the phase detection result.

8. The disk processing method according to claim 6, wherein in the detecting processing of the upper limit signal and the lower limit signal, signal detection with attack/release time constants is performed.

9. The disk processing method according to claim 6, wherein in the detecting processing of the upper limit signal and the lower limit signal, a first predetermined area or a second predetermined area is selected for every six WDUs, a wobble phase detection signal is selected depending on the selected area, and the upper limit signal and the lower limit signal are determined based on the above result.

10. The disk processing method according to claim 6, wherein in the detecting processing of the upper limit signal and the lower limit signal, the upper limit signal and the lower limit signal are determined after retarding a response speed to the respective wobble phase detection signals.
